(19) United States
(12) Patent Application Publication
(10) Pub. No.: US 2010/0230610 A1
(43) Pub. Date: Sep. 16, 2010

(54) INTEGRATED DEVICE HAVING AN ARRAY OF PHOTODETECTORS AND AN ARRAY OF SAMPLE SITES

(75) Inventors: Pieter Jan Van Der Zaag, Eindhoven (NL); Nigel David Young, Redhill (GB); Hendrik Roelof Stapert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/294,469

(22) PCT Filed: Mar. 20, 2007
(86) PCT No.: PCT/IB2007/050968

§ 371 Date: Sep. 25, 2008

(30) Foreign Application Priority Data
Mar. 28, 2006 (EP) 06111822.0

(51) Int. Cl. G01J 1/58; B23P 17/04

(52) U.S. Cl. 250/459.1; 250/458.1; 29/428; 250/200

(57) ABSTRACT

An integrated device for detecting emissions from a sample (70) involves forming an array of photo detectors (20) for detecting the emissions and forming an array of sites for receiving the sample such that edges of the sites are defined by edges of the photo detectors. A side wall of a site using a diode can provide a side wall suitable for ink-jet printing samples such as biomolecules with no extra mask steps. This helps enable the sample and the photo detector to be mutually aligned more easily or more cost effectively than conventional devices where the site for receiving the sample is formed separately from the photo detector. The detection can be in any direction, such as lateral or vertical detection. Lateral optical detection with a shielded photodiode means only light emanating from one pixel/spot is detected. A light source (200) to stimulate emissions can be integrated.

This invention relates to sensors and especially biosensors comprising devices such as semiconductor devices, especially semiconductor devices comprising LAE technology and having radiation detectors such as photodetectors arranged to detect radiation emission from samples, and to corresponding methods of manufacturing and use of such devices.

A known lab-on-chip platform comprises a disposable cartridge and a benchtop-sized or even hand held control instrument and reader that manages the interface between the operator and the chip. Such chips can be biochips. These are used for a variety of applications such as DNA analysis, in immuno-assays, sandwich assays or for identification or growing of bacterial cultures amongst other applications. The cartridge contains or is formed by a bio-chip. The high degree of integration of the miniature lab helps reduce the level of manual intervention and creates possibilities for multiplexed assays. A graphical user interface can be used to monitor the analysis in progress.

In the following reference will be made to DNA testing only as an example. The operator simply loads a sample for analysis and inserts the cartridge into the instrument. All chemical reactions occur inside the biochip's proprietary buried channels or on its surface. Because the cartridge that carries the chip is self-contained and disposable, the system strongly reduces the cross-contamination risks of conventional multistep protocols.

The example of DNA analysis can use DNA amplification, for example a PCR (polymerase-chain-reaction) process before or during detection. A DNA sample is mixed with a polymerase enzyme, DNA primers, nucleotides and salts and passed through a series of micro channels in the biochip, each measuring 150×200 microns, within the silicon. Electrical heating elements in the silicon—essentially resistors—heat the channels, cycling the mixture through three precise predetermined temperatures that amplify the DNA sample.

The system then uses MEMS actuators to push the amplified DNA into the biochip's detection area, which contains DNA fragments attached to the surface probe. There, matching DNA fragments in the sample, target DNA attach themselves to the fragments on the binding sites, whereas DNA fragments without matching patterns fall away. The system achieves accuracy by accurate temperature control. It detects the presence of the DNA fragments by illuminating them with a laser and observing which sites fluoresce.

Short chain ss-DNA complementary to DNA of various pathogens can be spotted on a substrate by printing, typically ink-jet printing. An example is SurePrint technology made by Agilent, as shown at www.chem.agilent.com. Upon hybridization with DNA fragments labeled with fluorophores, certain spots on the substrate will become emissive, evidence for the presence of pathogen DNA having bound to these respective spots.

It is known from US patent application 20050233366 to provide a sample analyzing device with photo diodes for detecting the fluorescence. A hydrophilic area is provided above each photo diode to gather a water based sample droplet which can be provided by an inkjet method. A hydrophobic area surrounds the hydrophilic area. The sample is illuminated with ultraviolet light to stimulate the fluorescence. A filter layer above the photo diode reduces the amount of ultraviolet light reaching the photodiode.

The use of integrated optical detection using a-Si photodiodes has been proposed in the display field notably in PLED displays. See M. J. Childs et al. WO 2005015530 A1.

It is known from US patent application 20050158738 to provide DNA microchips with thousands of sample droplets per square cm using inkjet methods onto a probe fixing carrier having division walls provided to keep such droplets separate and to provide a light shielding effect. An index marker is provided to enable alignment of the inkjet with the division walls.

An object of the invention is to provide improved devices, such as semiconductor devices, having a detector, such as a photodetector, arranged to detect radiation emissions from a sample, and to provide corresponding methods of manufacturing and use of such devices.

According to a first aspect, the invention provides:

A method of manufacturing an integrated device for detecting radiation emissions from a sample and having the steps of:

forming a radiation detector such as a photodetector, for detecting the radiation emissions, and

forming a site for receiving the sample such that one or more edges of the site are defined by one or more edges of the detector, e.g. photodetector.

The device can be implemented as a micro array.

In particular the present invention provides a method of manufacturing an integrated device for detecting radiation emissions from a sample and having the steps of:

forming an array of radiation detectors for detecting the radiation emissions and

forming an array of sites for receiving samples such that one or more edges of each site are defined by one or more edges of each of the radiation detectors.

The above methods help enable the sample and the radiation detector, e.g.

photodetector, to be mutually aligned more easily or more cost effectively than conventional devices where the site for receiving the sample is formed separately from the photodetector. The detection can be in any direction, such as lateral or vertical detection.

An additional feature of some embodiments is the radiation detector, e.g. photodetector being formed before the site is formed. This enables the site to be formed over or up to an edge of the photo detector, to help the mutual alignment. Alternatively it is also possible to form the site first and then form the photo detector.

An additional feature is the site being formed above the photo detector. This implies a vertical detection, which is typically more sensitive than lateral detection. The site can be formed up to the edges of the photo detector to ease or ensure mutual alignment.

An additional feature is the site and the radiation detector, e.g. photodetector, being formed side by side. This implies lateral detection.

Another such additional feature is forming the sites comprising forming a biosensitive layer capable of emitting radiation in the presence of a given type of sample.

Another aspect of the present invention provides:

An integrated device for detecting radiation emissions from a sample and having a radiation detector, such as a photodetector, for detecting the radiation emissions and a site for receiving the sample such that one or more edges of the site are formed by one or more edges of the radiation detector, e.g. photodetector. The device may be implemented as a micro array.

An additional feature of some embodiments is the site being above the photodetector.

Another such additional feature is the site and the photodetector being side by side.

An additional feature is the photodetector protruding higher than the site, to act as a side wall of the site. This can help contain the sample on the site, prevent cross-contamination, and reduce loss or reduce the dependence on accurate printing of the sample onto the center of the site.

An additional feature is the photodetector being arranged to surround the site. This helps enable more effective mutual alignment and more effective detection.

An additional feature is an integrated light source to illuminate the sample. This can reduce the need for external equipment and make the detection easier for an end user.

An additional feature is a light shield to shield the photodetector from emissions from other samples. This can help avoid cross talk and improve accuracy.

An additional feature is a metallic contact layer over a side of the photo detector to form the light shield. This makes use of the contact layer for dual purposes to help avoid the need for a separate layer for the shield, to reduce manufacturing complexity.

An additional feature is a hydrophilic surface at the site for receiving the sample.

An additional feature is the photodetector being in a thin film deposited semiconductor such as hydrogenated amorphous Si, normally indicated as a-Si:H. The material can be crystallized to the form of so-called poly-Si, e.g. using a laser. Conventionally as a laser is used to crystallize the material rather than a heating at high temperatures, this material is referred to as “low temperature poly-Si” e.g. LTPS. Such a material has a higher electron mobility then a-Si, thus thin film transistors made from the former material enable higher switch speeds. The advantage of a-Si is that it is easier to handle in production, as it does not have stringent processing conditions, which poly-Si TFTs require.

An additional feature is the photodetector comprising any suitable form of silicon on a transparent substrate, e.g. a thin film deposited onto a substrate such as glass.

An additional feature is the photodetector having a configuration of islands or indentations into the site. This helps reduce the lateral distance for the emissions to travel to the photo detector, and thus enables detection of emissions at higher angles of elevation to increase sensitivity of detection.

Another such additional feature is the sites having a biosensitive layer capable of emitting radiation in the presence of a given type of sample.

Another aspect of the present invention provides:

an integrated device for detecting radiation emissions from a sample and having a radiation detector such as a photodetector for detecting the radiation emissions and a site for receiving the sample, and a metallic layer over a side of the radiation detector, e.g. photodetector, to form a radiation, e.g. light shield to shield the detector, e.g. photodetector from radiation emissions from other samples. The device may be implemented as a micro array.

Another aspect of the present invention provides an integrated device for detecting radiation emissions from a sample and having a radiation detector, such as a photodetector, for detecting the radiation emissions and a site for receiving the sample, the detector, e.g. photodetector, comprising any suitable form of silicon on a transparent substrate, e.g. on glass. The device may be implemented as a micro array or biochip.

Another aspect of the present invention provides a method of detecting radiation emissions from a sample having the steps of applying a sample onto an integrated device as set out above, illuminating the sample, and using the radiation detector to detect radiation emissions from the sample. The device may be implemented as a micro array.

Any of the additional features can be combined together and combined with any of the aspects. Other advantages will be apparent to those skilled in the art, especially over other prior art. Numerous variations and modifications can be made without departing from the claims of the present invention. Therefore, it should be clearly understood that the form of the present invention is illustrative only and is not intended to limit the scope of the present invention.

How the present invention may be put into effect will now be described by way of example with reference to the appended drawings, in which:

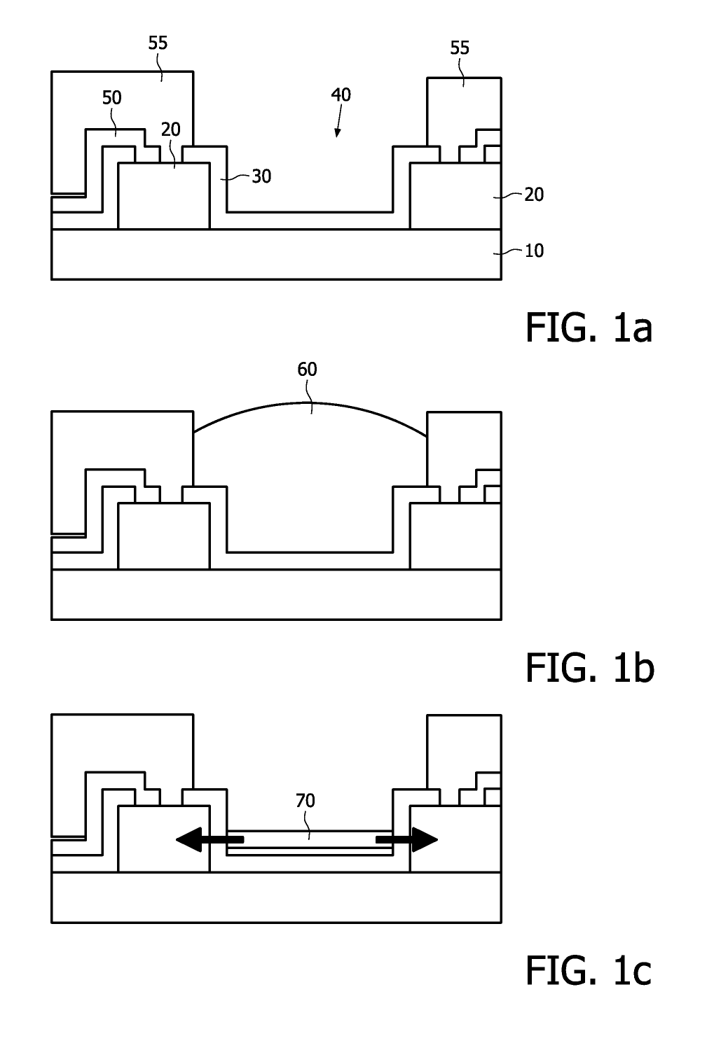

FIGS. 1a, 1b and 1c show schematic cross section views of an embodiment using a lateral a-Si diode also as a printing dam, before (1a) and after (1b) printing a sample, and after drying (1c) the sample then exposing the sample to a target sample that may contain DNA to cause hybridization of the sample,

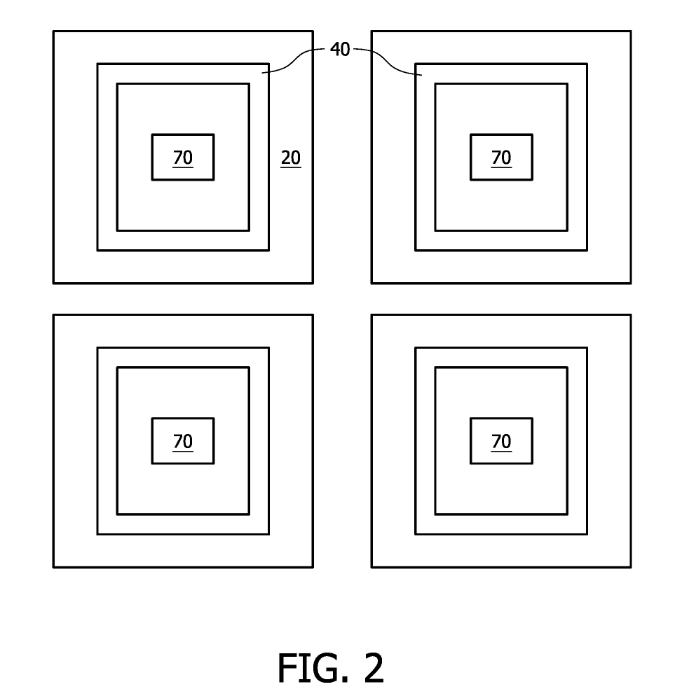

FIG. 2 shows a plan view of a similar embodiment, showing an array of four photo detectors and sample sites,

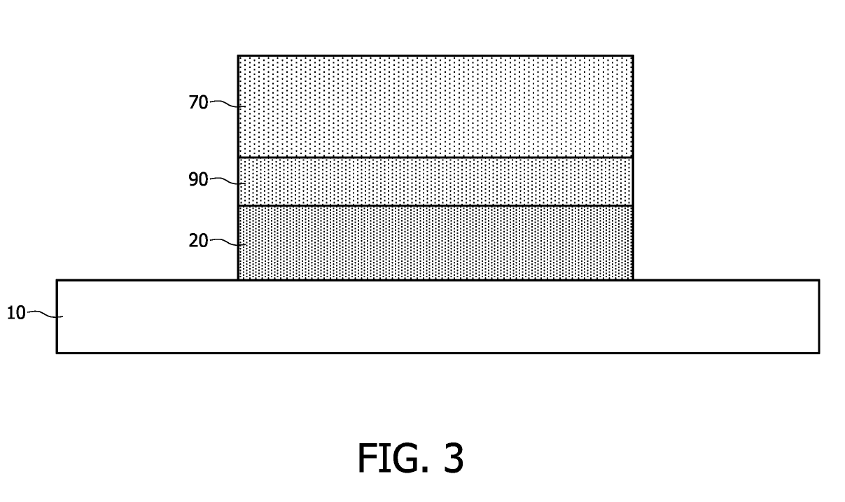

FIG. 3 shows a second embodiment with the site above the photo detector structure,

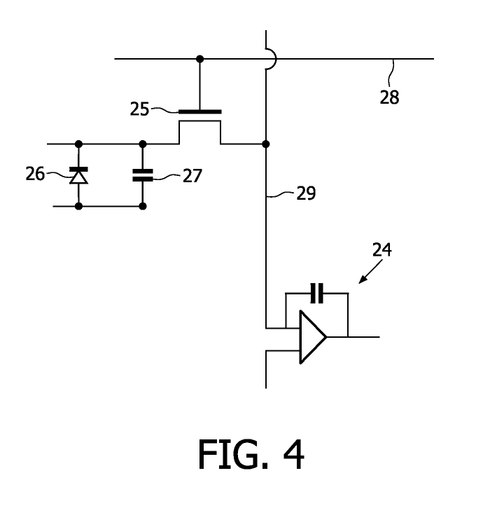

FIG. 4 shows a circuit diagram of part of an embodiment having an array of TFTs and photo-detectors,

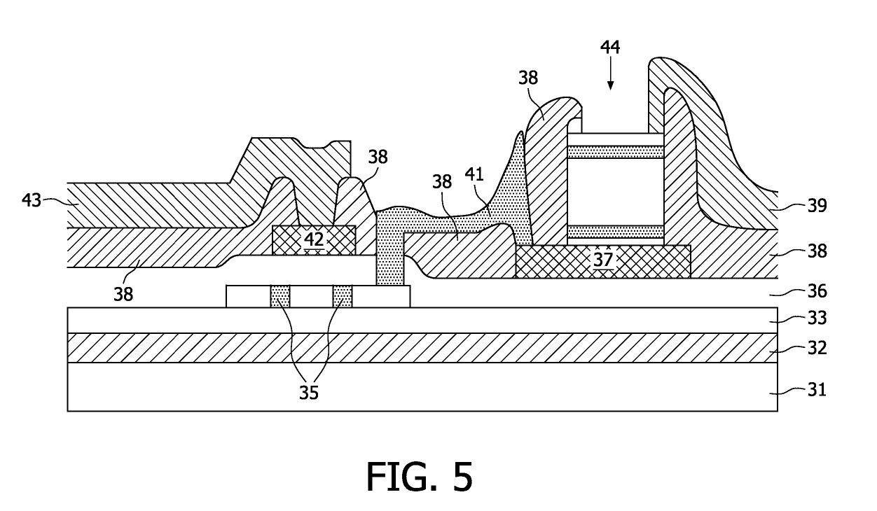

FIG. 5 shows a cross section view of an embodiment having TFTs and photo-detectors integrated,

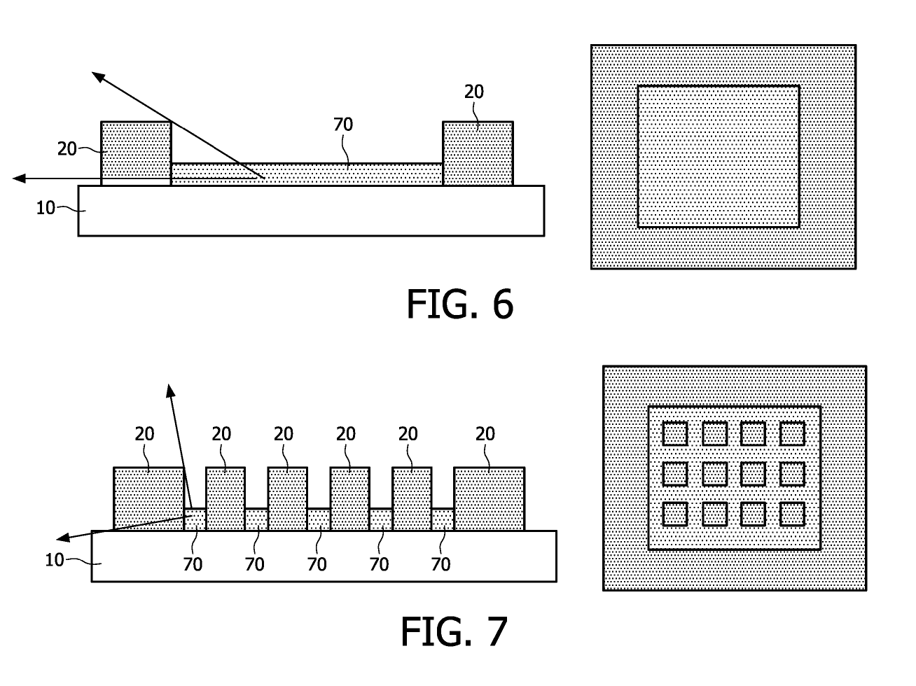

FIGS. 6 and 7 show schematic cross section views of further embodiments, and

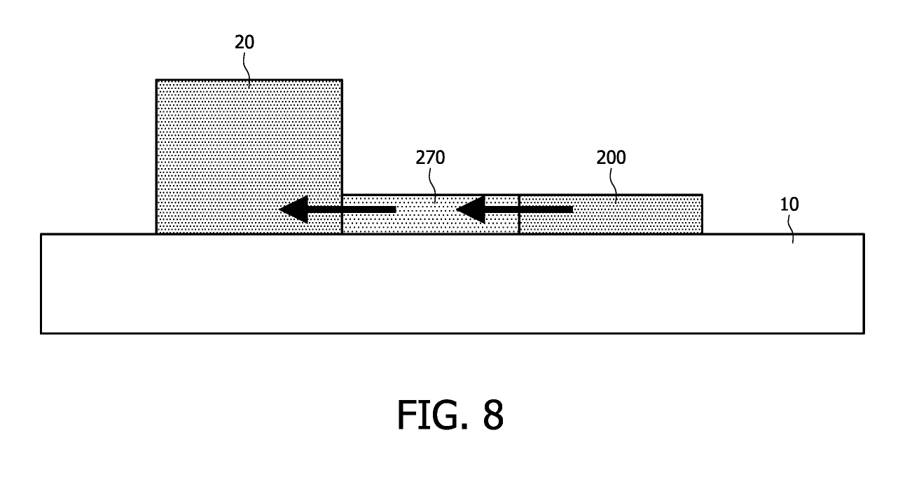

FIG. 8 shows a schematic cross section of another embodiment having a light source on the active plate.

The present invention will be described with respect to particular embodiments and with reference to certain drawings but the invention is not limited thereto but only by the claims. Any reference signs in the claims shall not be construed as limiting the scope. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The present invention relates to sensors such as biosensors which are formed from an array of radiation detectors such as NIP diode structures on a substrate, especially a transparent substrate, whereby at least a part of the radiation detectors is used as a self-aligning wall for guiding or locating the deposition or printing of a bio sensitive layer such as a probe in the form of spots, such that when the spots are dried, photo-emitting material in the spot or photo-emitting material attracted to and bound to the spot is in direct contact or aligned with the radiation detector. The probes can be immobilized or attached to the sites by non-covalent or covalent bonding. The probes can be any suitable molecule or molecules, e.g. parts of DNA, RNA, peptides, proteins, antibodies, drug conjugates, carbohydrates, cells, cell parts such as external or internal cell membranes or organelles, bacteria, viruses, etc. Also the probes may include combinations of these, e.g. cell proteins immobilized to the surface of a site may be suitable for immobilizing cells. The surface of sites for the probes may be treated to obtain useful properties to allow immobilization of the samples, e.g. the site surface may be made hydrophobic or hydrophilic. General methods of attaching biological molecular probes to the surface of substrates are known the skilled person—see for example “Micro array Technology and Its Application”, Müller and Nicolau, Springer, 2005, chapters 2 and 3. The spot area or probe site can be called a “pixel”. Hence in accordance with embodiments of the present invention an array of a number of probe sites is aligned with an array of an equal number of radiation detector sites, i.e. an array of biosensor pixels.

Alternatively, the pixels may be used as small incubation wells, for example for culturing of bacteria or other micro-organisms. In this case pixels need to be filled with growth medium before applying a sample of interest. The wells may be heated at certain temperatures, which can be applied by integrating heater elements (e.g. heating current wires) into or close to the wells. Different growth media may be applied to different wells to supply optimal culturing conditions. Additionally anti-microbial agents may be added to some wells to determine antibiotic resistance, i.e. via monitoring growth of the micro-organism.

In addition light shields can be applied to shield light from neighboring probe sites or pixels, e.g. to prevent cross-talk between pixels. The light shields can be combined with the use of the detector to provide an edge of the site for the spot, or independently of this.

Spot deposition can be done by any suitable technique, e.g. contact or non-contact printing, microspotting, solid or split pin or quill printing, pipetting or thermal, solenoid or piezoelectric ink-jet printing of liquid samples, e.g. in the form of biomolecules. The biomolecules are preferably probes, which bind to an analyte molecule whose presence is intended to be determined. Analyte molecules can be any molecules which need to be detected, e.g. DNA or RNA, fragments of DNA or RNA, DNA or RNA polymorphisms, peptides, proteins, antibodies, e.g. to be detected using sandwich immuno-assays, drug conjugates, carbohydrates, cells, cell parts such as external or internal cell membranes or organelles, bacteria, viruses, etc. To allow luminescence of the bound probes and analyte molecules, the probes and/or the analyte molecules can comprise or be attached to labels which provide the luminescence, e.g. by phosphorescence, fluorescence, electroluminescence, chemiluminescence, etc. When labeled, the probes or analyte molecules may be described as “variable optical molecules”. Once the analyte molecule and the probe are bound the light emission from the spot changes, e.g. it may emit chemiluminescence upon addition of a compound, or it may emit fluorescence if excited with excitation radiation of the correct wavelength. Other forms of light emission can be used, e.g. electroluminescence, with the present invention, e.g. by provision of the appropriate stimulant such as specific chemicals and an electric current. Also, any suitable form of detection can be used, e.g. vertical optical direction, i.e. in a direction substantially perpendicular to a major surface of the substrate or, for example, lateral optical detection, e.g. with a shielded photodiode such that only light emanating from one pixel/spot is detected. This would enable crucial quality control in the manufacturing process of cartridges for medical diagnostic applications.

The embodiments described below show examples of a number of the following aspects, at least one of which can be an advantage of the present invention:
a) Dual use of a radiation detector such as a photodetector (e.g. an a-Si PIN diode) as an alignment structure, e.g. as a deposition guide or location guide for deposition of biomolecules.
b) Dual use of a radiation detector such as a photo detector as a printing barrier.
c) Dual use of a metal contact layer for use in a radiation detector such as a photodetector and as a light shield from emissions from neighboring sites.
d) Use of LAE (large area electronics) poly-Si or a-Si technology on a transparent substrate such as glass, e.g. for medical diagnostics applications.

With reference to the latter, traditional large area electronics (LAE) technology offers electronic functionality to be provided on an insulating substrate such as glass, which is a cheap substrate. The substrate for use with the arrays of the present invention, e.g. glass, is preferably transparent or translucent. This can be an advantage for optical detection. Active LAE poly-Si or a-Si (amorphous silicon) substrates are proposed in embodiments of the present invention, for use in detection of sample spots that are emitting radiation without the use of external photo-detectors. Alternatively, poly-Si or a-Si (amorphous silicon) layers may be applied to an insulating substrate such as glass for use in detection of sample spots that are emitting radiation without the use of external photo-detectors. In either case an array of radiation detectors is integrated and aligned with the probe sites of the array on a substrate. Standard LAE technology can be used to integrate (at little or no extra costs) radiation detectors such as photo-diode or photo-TFT detectors together with the usual addressing TFTs and circuitry as well as read-out electronics.

Some embodiments enable optical detection and spot deposition, e.g. ink-jet printing, of probes such as DNA fragments/oligonucleotides, peptides or antibodies, for use in a wide range of applications. In addition LAE may be combined with thick layer polymer technology, e.g. the printing of conductive lines to provide a very economical solution.

Some embodiments show radiation detectors such as a-Si photodiodes (or photo TFTs) integrated in such a way into the substrate carrying the biological elements, e.g. probes such as DNA-fragments, that a part of the radiation detectors, e.g. a-Si NIP diodes, will also serve as a printing alignment structure e.g. dam-wall. The printing alignment is used to make sure that a deposited or printed probe is located in the correct area.

In the following two structures are described as embodiments of the present invention using the NIP diode and providing both detection and a printing alignment. A first is shown in FIGS. 1 and 2. In this embodiment a ring of a photodetector such as a diode is formed using the diode as a printing dam wall with a binding site inside, e.g. a hydrophilic region. See FIGS. 1a, 1b and 1c which show a sketch cross-section view at three stages, and FIG. 2, which gives a plan view of a layout. FIG. 1a shows a schematic cross-section view of an embodiment using lateral a-Si NIP diodes 20 which serve also as a printing wall or dam to form a well 40. The diodes 20 are formed on a substrate 10, e.g. a transparent substrate 10. The substrate 10 is preferably glass. The well 40 has sides and a base. An insulator layer 30 provides the sides and base of the well 40, e.g. is formed at the sides of the diode 20 and in the site for receiving the sample next to the diode 20. The insulating layer 30 is made of a material which is transparent to the emissions from the sample in well 40. The insulating layer 30 can be made of a hydrophilic material or it can be made hydrophilic, e.g. by a suitable coating or surface treatment. A top metal layer 50 is used to connect the diode 20 to readout circuitry and selection or multiplexing circuitry as appropriate following established design practice. This top metal 50 can be arranged to cover a side or sides of the diode 20 away from the sample site as shown for the left hand diode 20 in FIG. 1a. This means the top metal 50 can serve also as a light shield to prevent light from well 30 from reaching photodetectors further left in FIG. 1a than the left hand diode 20.

To insulate the exposed metal components from sample fluid to be added to the device during analysis thereof, an insulating layer 55 is applied, e.g. by depositing over the whole area an insulating layer and patterning by standard lithography. This insulating layer 55 may be hydrophilic or hydrophobic. If hydrophobic, the layer 55 may assist in directing aqueous solutions printed onto the device into the well 40. The layer 55 may be optically opaque and thus act as a shield to stray light or to light from the samples in the wells 40 thus preventing cross-talk between photodetectors and improving signal to noise ratio.

In accordance with embodiments of the present invention more than one biological binding site can be associated with one photodetector. In such an arrangement it can be advantageous to deposit several spots in one diode well 40. In general, alignment structures within each well 40 of the present invention can work by having two regions next to each other, a hydrophobic and a hydrophilic region. When a hydrophilic or water based ink is printed it congregates in, or automatically pulls itself over to the hydrophilic region, and then dries in alignment with this location. In this manner the base of a single well 40 may be partitioned into several binding sites. An advantage of this arrangement is that light from more than one binding site reaches a single photodetector 20 whose output is then an average result for that site.

FIG. 1b shows the structure after printing with a spot 60 in the form of a droplet containing a sample or probe in the well 40. The droplet is shown not centered on the site, but the walls of the site formed by the insulator layer 30 and/or the NIP diode 20 serve to retain the droplet sufficiently so that as it dries, e.g. capillary action will draw substantially all the deposited material into the site. FIG. 1c shows the structure after drying, and ready for detection. By exposing the dried spot 70 of the sample to a molecule that binds to the probe, e.g. complementary DNA, hybridization occurs. If either the probe or the sample molecule is labeled, the boundsample becomes fluorescent when illuminated. This fluorescent light can be detected by the photodiode 20 and used to confirm the presence of the given complementary type of analyte molecule, e.g. DNA. Of course other applications can be envisaged, and other types of photodetector can be used. For example, the emission of light may be generated by other means than by fluorescence and some molecules emit light on binding without the use of labels.

The exposing of the sample can be carried out manually or can be automated by means of MEMS devices for driving fluids along microchannels into and out of the site. If needed, the temperature of the fluids and the site can be controlled precisely.

FIG. 2 shows a plan view sketch of one particular layout, which could be used. This arrangement may be formed as an active matrix row and column array of pixels, with a TFT switch used to select each pixel and a capacitor to store charge transferred from the photodetector when illuminated (not shown). In FIG. 2, an array of four sites each having a spot 70 is shown, each spot being surrounded by a detector in the form of diodes 20. Typically in ink-jet printing (IJP) of sample liquids, as for instance, done in the PolyLed technology, dam walls are useful or needed to ensure that the printed solution is deposited at a very well defined position. Otherwise detection accuracy or reliability can suffer. Notably the structure of the PIN-diode is also used a printing dam wall. An a-Si PIN diode is around 0.2-1.0 μm (micron) high whereas the biological elements such as the probe in many examples, once dried is less than 500 nm sometimes less than 50 nm high. Hence the diode structure protrudes sufficiently to create an effective dam. If necessary the diode structure can be made higher to suit the application and the size of droplets to be printed. For example, as shown in FIG. 1a an additional insulating layer 55 may be used to increase the depth of the well 40. With respect to the height of the biological elements such as probes to be optically detected, e.g. typically a base-pair has a length of 0.34 nm, if 25 or 60 oligo-nucleotides are to be used, their estimated total length (i.e. the maximum height) often do not exceed 50 nm. Labeled DNA amplicons that can be the target molecules typically are between 100 and 700 base pairs long and often have a maximum height of less than 400 nm. Sandwich immuno assays can have a height of less than 150 nm.

Note that lateral optical detection, as shown in FIG. 1c, ensures that detection is done orthogonally to the excitation direction, e.g. in FIG. 1c, the excitation using an excitation light beam is done from the top or the bottom of the glass substrate (i.e. from above or below the substrate 10 in FIG. 1c) and the detection is done in a direction parallel to the plane of the substrate 10, whereby the detection of scatter light is immediately reduced. This is one of the key advantages of using LAE technology, and is possible since a glass substrate 10 is used. Also the NIP diode structure and the label or fluorophore can be chosen for maximum sensitivity to the light emitted by the samples also known as probes.

In a second structure according to another embodiment, shown in FIG. 3, a circle of diode material can be made with a hydrophilic surface, so that the ink remains on top of the diode. This is shown in FIG. 3. The photo detector in the form of an NIP diode 20 is formed on substrate 10, and used as a printing alignment structure. The site is above the diode and spot 70 is printed on top of the diode so that the edges of the diode define the edge of the site and thus any parts of the spot that are printed beyond the edge are drawn in by capillary action or fall onto hydrophobic areas and cannot stick to the device.

A notable difference between these two structures is in the former the excitation radiation, e.g. excitation light is coupled in at 90° which reduces the amount of excitation light “seen” by the light detector.

The second structure requires measures such as a filter layer 90 or a judiciously chosen combination of laser wavelength and fluorophore to avoid directly detecting the excitation light. In this detection scheme quantum dots are suitable owing to their very broad absorption, while their emission band is narrow and can be tuned, well away from the excitation wavelength, i.e. due to their large Stokes shift. Consequently, a simple filter would suffice to avoid detecting the excitation (laser) light).

An advantage of the second structure is that vertical NIP diodes are more sensitive than lateral NIP diodes. So depending on the application one might choose either one of these layouts.

The above embodiments represent a novel way of combining two functions, i.e. radiation detector and site alignment, e.g. printing alignment on the same substrate. For ink-jet printing on certain substrates such as glass, dam walls are advantageous to be sure where printed substance will remain. This makes the use of a wider variety of substrates possible rather than being restricted to substances with the right contact angle, i.e. surface tension.

Integrated optical detection gives better robustness than using an external photodetector, especially for handheld applications. For example, no moisture or contaminants can come between the spot and the detector. The detector is preferably sensitive to light from only one site sometimes called a pixel. This helps enable quality control upon deposition. Such quality control can be crucial in the manufacturing and quality assurance of cartridges for medical diagnostics. Optionally, an on-chip test and feedback path between the substrate and the printer can be implemented which would assure that not-printed spots/pixels are correctly reprinted, e.g. at a later time. This feedback could be implemented in software e.g. in the form of printing surveillance and printing quality control software. This could greatly improve the yield and reliability with which cartridges can be produced.

FIG. 4 shows a circuit diagram for a part of an integrated array of detectors in accordance with an embodiment of the present invention. It should be understood that a number of radiation detectors such as photodiodes 26 are arranged in an array with readout electronics integrated with the photodiodes 26, e.g. in an array of columns and rows. The array of detectors is addressed logically in terms of columns and rows. There are a plurality of row or scan lines 28 and a plurality of column or readout lines 29. At each intersection of a scan and column line, a pixel is located. The readout electronics includes a select means for each radiation detector, such as a select transistor 25 for coupling a radiation detector such as a photo-detector, e.g. in the form of a photodiode 26 to a readout line 29 of the readout electronics (column) which is connected to an input of an integrator, e.g. at the base of each column. The integrator 24 can be formed by an amplifier such as an op amp having capacitive feedback. Photocurrent from the diode is allowed to accumulate on the storage capacitor 27 over a defined frame time. The gate of the select transistor 25 is coupled to a scan line (row) 28 so that when the scan line is activated, the select transistor 25 transfers the accumulated charge to the integrator 24. In some instances the self-capacitance of the diode is adequate to accumulate the charge.

FIG. 5 shows a cross section view of an embodiment of a top gated NMOS LTPS technology which may be used for the present application for circuits such as that shown in FIG. 4. It can be used as one way of implementing a vertical structure as shown in FIG. 3. An alternative is to use a-Si technology in which normally the TFTs are bottom gated. In FIG. 5, an NMOS TFT 34 is shown on the left side of the figure and a NIP photodetector 44 on the right side. The layers from the bottom to the top are as follows. The lowest layer is a transparent substrate 31 such as glass, the next layer on top is an insulating layer 32 such as SiNx (silicon nitride), the next layer is also an insulating layer 33 such as SiO₂ (silicon dioxide). The layer 35 above this silicon dioxide layer 33, and sandwiched below another silicon oxide layer 36, is a thin film deposited crystallized poly-Si layer with differently doped regions, i.e. to form an active semiconductor layer 35. Generally, two metal layers are used to wire together the semiconductor devices, and these are separated by a dielectric layer 38 such as silicon nitride. The bottom-most metal is used for the transistor gate electrodes 42 and also to form the bottom connection to the diode 37. A suitable conductive metal e.g. Cr/Al is used for this purpose. The topmost metal 39, 41, 43 wires various items together and forms the column lines of the array orthoganally to the gate lines in the bottom most metal. Not shown in the figure is an insulating layer such as layer 55 of FIG. 1 which is a applied to insulate the exposed metal from the sample fluid. This insulating layer may be applied by standard techniques. For the topmost metal, any suitable metallic material such as a metal, e.g. the Cr/Al/Cr stack can be used. The TFT transistor 34 is shown with a lightly doped drain structure 35. This is coupled by a conductive metal connection 41 to one contact 37 of the photodiode. Other parts of the circuit of FIG. 4 including the storage capacitor and integrator can be implemented using established techniques.

The capacitor integrated into the pixel site allows the light to be integrated over a certain time, e.g. a long frame time period and then read out.

In an alternative embodiment the NIP photo-detector 20 can be integrated in an active plate comprising both n- and p-type TFTs (thin film transistor) e.g. in a CMOS type technology.

The use of thin film transistor technology for the pixel circuit also allows other circuitry to be added such as the integration of the drive, charge integration, and read-out circuitry. The photo detectors can be any suitable radiation detectors such as TFTs, (Thin Film Transistors) which are gate-biased in the off-state, or lateral diodes made in the same thin semiconductor film as the TFTs, or vertical diodes formed from a second, thicker, semiconductor layer. For high sensitivity vertical a-Si:H NIP diodes are preferably used. These are preferably integrated into the addressing TFTs and circuitry. The present invention includes such a scheme implemented either in a-Si:H TFT technology, or in LTPS technology. In the latter case the diode integration is achieved at the expense of only one extra mask cost, and a typical cross-section for the technology is shown in FIG. 6.

FIGS. 6 and 7 show views of alternative arrangements of photo diode layouts, in cross section and plan view in each case. FIG. 6 corresponds to FIG. 2, and shows how radiation emissions above a given angle of elevation will not be detected. FIG. 7 shows an arrangement which can detect more of these emissions and so provide an increase in the optical detection sensitivity. In FIG. 7 the diode 20 has many small sections located in the site of the spot 70. This shows that by reducing the distance to the nearest section of the diode, more emissions having higher angles of elevation will be detected, simply by altering the configuration and position of the sections of the diodes. See FIG. 5 for an example of how to use the top metal to connect the diode sections together.

FIG. 8 shows another embodiment with additional integration of light sources 200 (such as OLEDS or PLEDs) to locally stimulate the emission of a single spot 270 next to a detector 20. This could avoid optical and electrical cross talk, and other noise effects. This could therefore provide increased robustness for, for instance, hand-held applications to counter bio-terrorism/warfare. This arrangement is shown schematically in FIG. 8. The light sources could be driven by the same active matrix array with an appropriate pixel circuit or an additional array in parallel. In such a scheme quantum-dots can be used for the detection, since they have a very broad adsorption band. Hence, they are capable being excited by any suitable wavelength emitted by, for example, an emissive polymer (e.g. OLED or PLED). Given the large Stokes shift of quantum dots they have the further advantage that the detection can be sufficiently far away (in wavelength) from the emission to allow for a reliable and easy to implement detection.

In an additional embodiment an external light source can be used to excite the whole plate simultaneously. External or integrated LED light sources can be used. In particular, laser light sources may be used. In such cases background excitation should be filtered out.

In practical implementations of these schemes (i) the light should be efficiently coupled to the detector, (ii) the printed spots should be closely registered (if possible self-aligned) to the detectors and (iii) the detectors should be effectively screened from the light of adjacent pixels.

In conclusion, some embodiments are notable for the radiation detectors such as NIP diode structures being used as a self-aligning wall for the deposition or printing of spots, such that when the spots are dried the photo-emitting material is in direct contact or aligned with the detector, e.g. NIP structure with the light coupling in through the side. The top and/or bottom metal contacts of the detector, e.g. NIP can readily be patterned to shield light from neighboring pixels, either combined with the use of the detector to provide an edge of the site for the spot, or independently of this.

As described above, a dam wall comprised of a part of the radiation detector such as an a-Si PIN diode, at no extra costs (no extra mask steps) can provide the side wall suitable for deposition or ink-jet printing of samples in the form of biomolecules. As described above, a separate or combined aspect is lateral optical detection with a shielded photodiode such that only light emanating from only one pixel or spot is detected. This would enable crucial quality control in the manufacturing process of cartridges for medical diagnostic applications.

1. A method of manufacturing an integrated device for detecting radiation emissions from a sample and having the steps of:
forming an array of radiation detectors (20) for detecting the radiation emissions and forming an array of sites for receiving samples (70) such that one or more edges of each site are defined by one or more edges of each of the radiation detectors.

2. The method of claim 1, the radiation detectors being formed before the sites are formed.

3. The method of claim 1, the sites being formed above the radiation detectors.

4. The method of claim 1, the sites and the radiation detectors being formed side by side.

5. The method of claim 1, the step of forming the sites comprising forming a biosensitive layer capable of emitting radiation in the presence of a given type of sample.

6. The method of claim 1, wherein the sites are wells (40).

7. The method of claim 6, wherein the well is an incubation well.

8. An integrated device for detecting radiation emissions from a sample (70) and having an array of radiation detectors (20) for detecting the radiation emissions and an array of sites for receiving samples such that one or more edges of each site are formed by one or more edges of each radiation detector.

9. The integrated device of claim 8, the sites being located above the radiation detectors.

10. The integrated device of claim 8, the sites and the radiation detectors being side by side.

11. The integrated device of claim 8, the radiation detectors protruding higher than the sites from the substrate, to act as side walls of the sites.

12. The integrated device of claim 8, each radiation detector being arranged to surround a site.

13. The integrated device of claim 8 having an integrated light source (200) to illuminate the samples.

14. The integrated device of claim 8 each radiation detector having a light shield to shield the detector from emissions from other samples.

15. The integrated device of claim 8 having a metallic contact layer (50) over a side of each radiation detector to form a light shield.

16. The integrated device of claim 8 having a hydrophilic surface at the sites for receiving the samples.

17. The integrated device of claim 8, the radiation detectors comprising Si on a glass substrate.

18. The integrated device of claim 8, each radiation detector having a configuration of islands or indentations into a site.

19. The integrated device of claim 8, the sites having a biosensitive layer capable of emitting radiation in the presence of a given type of sample.

20. An integrated device for detecting radiation emissions from a sample and having an array of radiations detector (20) for detecting the radiation emissions and an array of sites for receiving samples (70), and a metallic layer (50) over a side of each of the radiation detectors to form a light shield to shield the radiation detector from emissions from other samples.

21. An integrated device for detecting radiation emissions from a sample and having an array of radiation detectors (20) for detecting the emissions and an array of sites for receiving the samples (70), the radiation detectors detector comprising a Si on a glass substrate.

22. A method of detecting radiation emissions from a sample having the steps of applying samples (70) onto an integrated device according to claim 6, illuminating the sample, and using the radiation detectors (20) to detect emissions from the sample.
